(19) United States
(12) Patent Application Publication
(10) Pub. No.: US 2014/0306011 A1
(43) Pub. Date: Oct. 16, 2014

(54) CARD READER

(71) Applicant: I/O INTERCONNECT INC., Taipei City (TW)

(72) Inventor: Johnny Chen, Taipei City (TW)

(73) Assignee: I/O Interconnect INC., Taipei City (TW)

(21) Appl. No.: 13/863,341

(22) Filed: Apr. 15, 2013

(51) Int. Cl. G06K 7/06

(52) U.S. Cl. CPC G06K 7/065
USPC 235/441

(57) ABSTRACT

A card reader for multiple memory cards is disclosed, which includes a substrate, a first contact arrangement, a second contact arrangement, a first controller chip and a second controller chip. The first and second contact arrangements are disposed on the substrate. The first and second controller chips are respectively electrically connected to the first and second contact arrangements for independently accessing memory cards.

### BACKGROUND OF THE INVENTION

1. Field of the Invention

The present invention relates to a card reader and, more particularly, to a connector structure for multi-storage media, which has a plurality of contact arrangements in a housing for contacting any of a variety of flash memory cards.

2. Description of the Related Art

Flash memory cards bring convenience to information industries for storage of data. Generally, flash memory cards are portable data input devices which are electrically connected to personal computers or other electronic apparatus. By means of the use of a single piece of flash memory, the e data stored in the memory cards is transferred to the electronic apparatus by inserting and extracting the card from a connector mounted in the electronic apparatus as needed.

Flash memory cards, for example, include SD cards (Secure Digital Cards) and CF cards (Compact Flash cards Type I and Type). Since commercially available read write apparatus commonly have only one slot for the loading of a particular model of flash memory card. For reading a different model of memory card, the user may have to change the read write apparatus. Therefore, an card reader that accepts different flash memory cards is desired.

### BRIEF SUMMARY OF THE INVENTION

One of the objective of the disclosure is to provide a cost effective, a simple modification and easily implementable card reader for accessing multiple memory cards.

In one embodiment of the disclosure, the card reader includes: a shousing, a first contact arrangement, a second contact arrangement, a first controller chip and a second controller chip. The first and second contact arrangements are disposed in the housing. The first and second controller chips are respectively electrically connected to the first and second contact arrangements. Arrange such that when inserting a memory card into the card reader, a plurality of contacts of the memory card can contact with the first contact arrangement or the second contact arrangement, for independently accessing said memory card by the corresponding first controller chip or the second controller chip.

In the other embodiment, the card reader includes: a first card slot, a second card slot, a first contact arrangement, a second contact arrangement a first controller chip and a second controller chip. The first card slot is configured to receive a first memory card via a first opening, and the second card slot is configured to receive a second memory card via a second opening. The first contact arrangement is disposed in the first card slot for contacting contacts of the first memory card inserted in the first opening of the first card slot, and the second contact arrangement is disposed in the second card slot for contacting contacts of the second memory card inserted in the second opening of the second card slot. The first and second controller chips are respectively electrically connected to the first and second contact arrangements, for independently accessing the first and second memory card.

In the above-mentioned embodiment, the first and second card slots are arranged side by side in a vertical direction or in a horizontal direction.

In yet still the other embodiment, the card reader includes: a housing with an opening, a substrate, a first contact arrangement, a second contact arrangement, a first controller chip and a second controller chip. The substrate is disposed in the housing and has a first surface and a second surface opposite to the first surface, wherein a first card slot is defined by an upper wall of the housing and the first surface of the substrate, and a second card slot is defined by a lower wall of the housing and the first surface of the substrate. The first contact arrangement is disposed in the first card slot for contacting contacts of a first memory card inserted in the card slot via the opening, and the second contact arrangement is disposed in the second card slot for contacting contacts of a second memory card inserted in the card slot via the opening. The first and second controller chips are respectively electrically connected to the first and second contact arrangements, for independently accessing the first and second memory card.

In the above-mentioned embodiment, the first controller chip is disposed on the first surface of the substrate and the second controller chip is disposed on the second surface of the substrate.

In any one of the above-mentioned embodiments, the first controller chip comprises a first ground pin, and the second controller chip comprises a second ground pin, wherein the first ground pin and the second ground pin are electrically connected to the other one.

In any one of the above-mentioned embodiments, the first controller chip comprises a first power pin, and the second controller chip comprises a second power pin, wherein the first power pin and the second power pin are electrically connected to the other one.

In any one of the above-mentioned embodiments, an external shape and dimensions of first contact arrangement follows a SD memory card standard, and an external shape and dimensions of second contact arrangement follows a Compact Flash (CF) memory card standard.

### BRIEF DESCRIPTION OF THE DRAWINGS

The invention can be more fully understood by reading the subsequent detailed description and examples with references made to the accompanying drawings, wherein:

FIG. 1 shows a front view of a card reader in accordance with a first embodiment of the disclosure;

FIG. 2 shows a top view of partial elements of the card reader shown in FIG. 1;

FIG. 3 shows a top view of partial elements of a card reader in accordance with a second embodiment of the disclosure;

FIG. 4 shows a front view of a card reader in accordance with a third embodiment of the disclosure;

FIG. 5 shows a front view of a card reader in accordance with a fourth embodiment of the disclosure; and

FIG. 6 shows a cross-sectional view of partial elements of a card reader in accordance with the fourth embodiment of the disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims

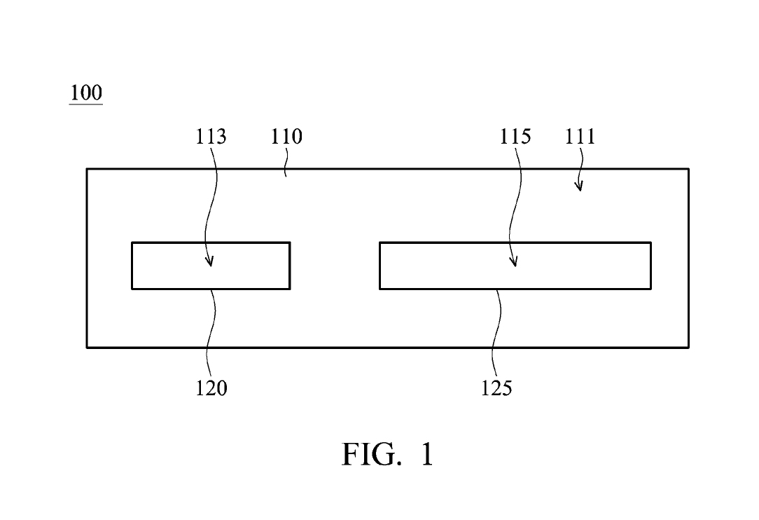

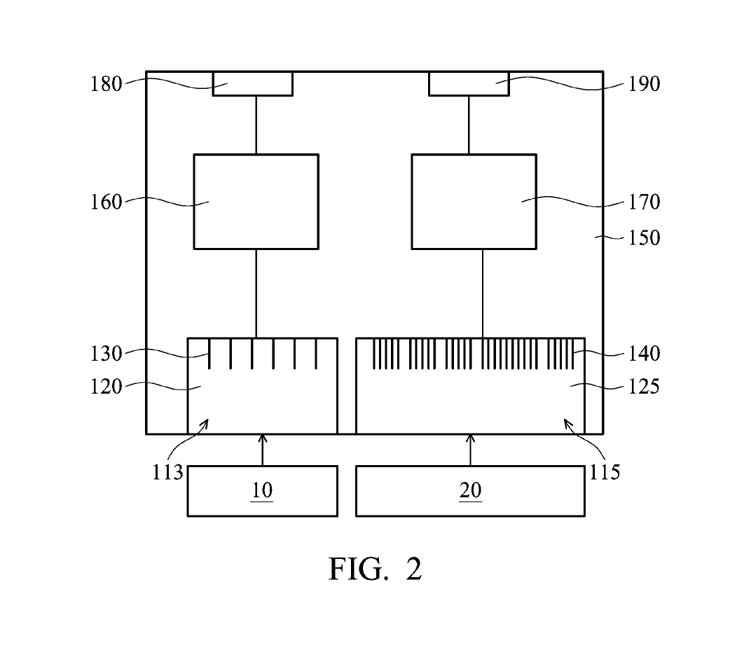

Referring to FIGS. 1 and 2, according to one aspect of the present disclosure, the card reader 100 can work with multiple types of flash memory cards 10 and 20, wherein the card reader 100 has separate slots for holding each type of flash-memory cards and separate controller chips for independently accessing each of the flash-memory cards.

The structural features of the card reader 100 are described in detail hereinafter. The card reader 100 includes a housing 110, a first contact arrangement 130, a second contact arrangement 140, a substrate 150, a first controller chip 160, a second controller chip 170, a first connector 180 and a second connector 190.

The housing 110 is made of electrically insulating material and has a first and a second card slot 120 and 125 horizontally inwardly extended from the front side 111 of the housing 10 and arranged side by side in a horizontal direction, wherein the first and second card slots 120 and 125 are respectively exposed to an outside surrounding by two openings 113 and 115 for receiving memory cards 10 and 20 inserted therein.

As shown in FIG. 2, the first contact arrangement 130 corresponding to the first card slot 120 is disposed on the substrate 150, and the second contact arrangement 140 corresponding to the second card slot 125 is disposed on the substrate 150. In this embodiment, an external shape and dimensions of the first contact arrangement 130 follows a SD memory card standard, and an external shape and dimensions of second contact arrangement 140 follows a Compact Flash (CF) memory card standard, but it should not be limited thereto. The first and second contact arrangements may differentiate the pin configuration for each flash memory media type.

The first controller 160 is electrically connected to the first contact arrangement 130, and the second controller chip 170 is electrically connected to the second contact arrangement 140, thereby when inserting memory cards 10 and 20 into the card reader 100, a plurality of contacts of the memory cards 10 and 20 can contact with the first contact arrangement 130 or the second contact arrangement 140, for independently accessing said memory cards 10 and 20 by the corresponding first controller chip 160 or the second controller chip 170.

Specifically, the first and second controller chip 160 and 170 execute various routines to perform handshaking with the flash-memory cards 10 and 20 and accept data, either serially or in parallel. The data is buffered and then sent to the host PC (now shown) through the first and second connectors 180 and 190 respectively. In this embodiment, card reader 100 is contained in an external housing that connects to host PC (now shown) through a USB cable. However, other cables and interfaces such as IEEE 1394 FireWire may be substituted. Additionally, the two controller chips 160 and 170 in card reader 200 allows for card-to-card transfers. For example, images or other files from memory card 10 could be transferred to memory card 20 by first controller chip 160 reading serial data from memory card 10 inserted into first card slot 120, and by second controller chip 170 writing into memory card 20.

It is noted that, in this embodiment, the first controller chip 160 and the second controller chip 170 are separated, wherein the power pins (not shown) of each of the first and second controller chips 160 are respectively connected to the first and second connectors 180 and 190, and the ground pins (not shown) of each of the first and second controller chips 160 are respectively connected to the first and second connectors 180 and 190. That is, each of the first and second controller chips 160 and 170 may be functioned independently while the other controller chip is switched off, thereby avoiding power waste.

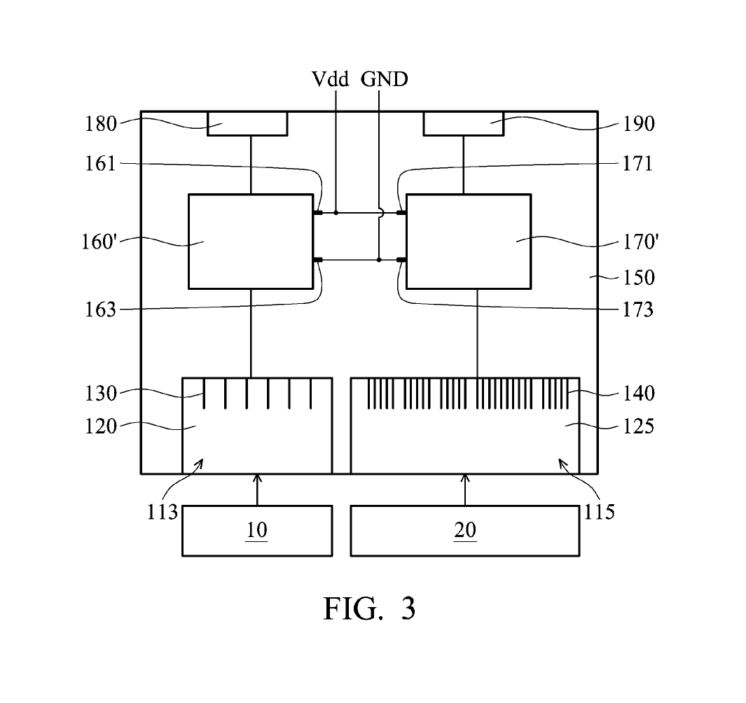

In accordance with an alternative embodiment of the disclosure, the power pins and ground pins of the controller chips 160 and 170 are connected to one the other. For example, as shown in FIG. 3, the first controller chip 160 comprises a first power pin 161 and a first ground pin 163, and the second controller chip 170 comprises a second power pin 171 and a second ground pin 173, wherein the first power pin 161 and the second power pin 171 are electrically connected to the other one, and the first ground pin 163 and the second ground pin 173 are electrically connected to the other one.

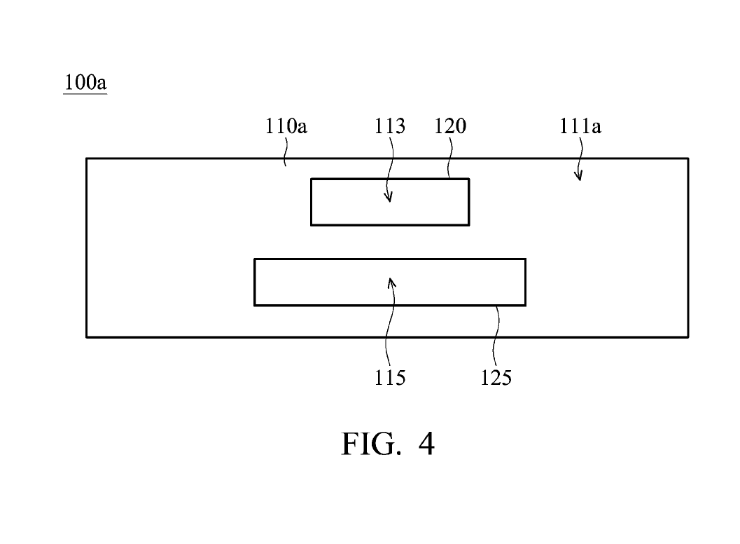

The arrangement of the card slots 120 and 125 should not be limited by the above-mentioned embodiment. For example, as shown in FIG. 4, the card reader 100a has a first and a second card slot 120 and 125 horizontally inwardly extended from the front side 111a of the housing 10 and arranged side by side in a vertical direction.

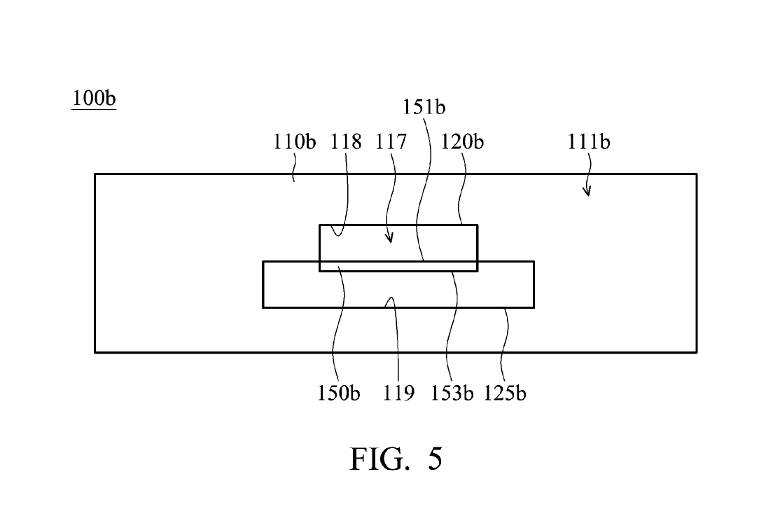

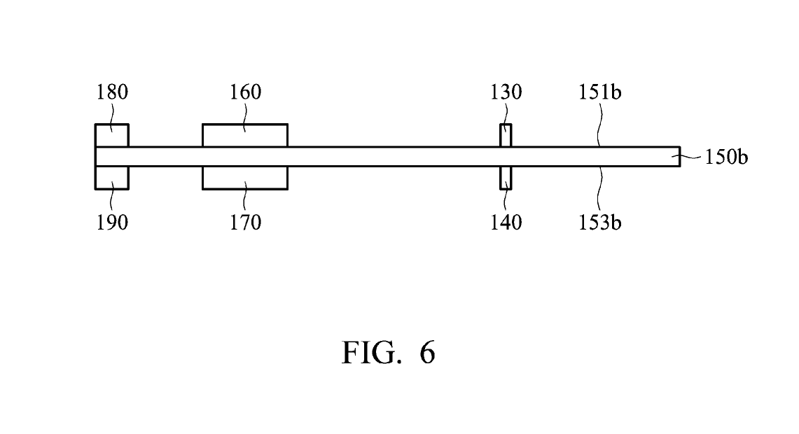

Referring to FIGS. 5 and 6, a front view of a card reader 100b in accordance with a fourth embodiment of the disclosure is shown in FIGS. 5 and 6, in which elements similar with that of the card reader 100 shown in FIGS. 1 and 2 are provided with the same reference numbers, thus, the features thereof are not reiterated in the interest of brevity. The card reader 100b includes a housing 110b, a first contact arrangement 130, a second contact arrangement 140, a substrate 150b, a first controller chip 160, a second controller chip 170, a first connector 180 and a second connector 190.

The housing 110b is made of electrically insulating material and has an opening 117 disposed on the front side of the housing 110b. The substrate 150b is corresponding to the opening 117 disposed in the housing 110b. The substrate 150b has a first surface 151b and a second surface 153b opposite to the first surface 151b. A first card slot 120b horizontally inwardly extended from the front side 111b of the housing 110b is adjacent to the first surface 151b of the substrate 150b, and a second card slot 125b horizontally inwardly extended from the front side 111b of the housing 110b is adjacent to the second surface 153b of the substrate 150b. That is, the two card slots 120b and 125b exposed to an outside surrounding by the same opening 117 for receiving memory cards 10 and 20 inserted therein.

As shown in FIG. 6, the first contact arrangement 130, the first controller chip 160 and the first connector 180 is disposed on a first surface 151b of the substrate 150b, and the second contact arrangement 140, the second controller chip 170 and the second connector 190 are disposed on the second surface 153b of the substrate 150b. While operation, two memory card may simultaneously plugged into the first and second card slots 120b and 125b, and contacts thereof are contact with the first and second contact arrangements 130 and 140. Thus, a compactness card reader 100b may be achieved.

By the arrangement that two or more than two controller chips are independently connected to contact arrangements which are follows a particular memory card standard, the card reader may accept different flash memory cards. Also, since each of the controller chips is used to access a single type of memory card, a use of complex controller chip can be avoided and a cost of the card reader may be reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A card reader for multiple memory cards, comprising:
a housing;
a first contact arrangement disposed in the housing;
a second contact arrangement disposed in the housing;
a first controller chip, electrically connected to the first contact arrangement; and
a second controller chip, electrically connected to the second contact arrangement, thereby when inserting a memory card into the card reader, a plurality of contacts of the memory card can contact with the first contact arrangement or the second contact arrangement, for independently accessing the memory card by the corresponding first controller chip or the second controller chip.

2. The card reader as claimed in claim 1, wherein the first controller chip comprises a first ground pin, and the second controller chip comprises a second ground pin, wherein the first ground pin and the second ground pin are electrically connected to the other one.

3. The card reader as claimed in claim 1, wherein the first controller chip comprises a first power pin, and the second controller chip comprises a second power pin, wherein the first power pin and the second power pin are electrically connected to the other one.

4. The card reader as claimed in claim 1, wherein an external shape and dimensions of first contact arrangement follows a SD memory card standard, and an external shape and dimensions of second contact arrangement follows a Compact Flash (CF) memory card standard.

5. A card reader for multiple memory cards, comprising:
a first card slot for receiving a first memory card via a first opening;
a second card slot for receiving a second memory card via a second opening;
a first contact arrangement disposed in the first card slot for contacting contacts of the first memory card inserted in the first opening of the first card slot;
a second contact arrangement disposed in the second card slot for contacting contacts of the second memory card inserted in the second opening of the second card slot;
a first controller chip, electrically connected to the first contact arrangement, for independently accessing the first memory card; and
a second controller chip, electrically connected to the second contact arrangement, for independently accessing the second memory card.

6. The card reader as claimed in claim 5, wherein the first controller chip comprises a first ground pin, and the second controller chip comprises a second ground pin, wherein the first ground pin and the second ground pin are electrically connected to the other one.

7. The card reader as claimed in claim 5, wherein the first controller chip comprises a first power pin, and the second controller chip comprises a second power pin, wherein the first power pin and the second power pin are electrically connected to the other one.

8. The card reader as claimed in claim 5, wherein an external shape and dimensions of first contact arrangement follows a SD memory card standard, and an external shape and dimensions of second contact arrangement follows a Compact Flash (CF) memory card standard.

9. The card reader as claimed in claim 5, wherein the first and second card slots are arranged side by side in a vertical direction.

10. The card reader as claimed in claim 5, wherein the first and second card slots are arranged side by side in a horizontal direction.

11. A card reader for multiple memory cards, comprising:
a housing with an opening;
a substrate disposed in the housing and having a first surface and a second surface opposite to the first surface, wherein a first card slot and a second card slot are inwardly extended from the opening and respectively adjacent to the first and second surface of the substrate;
a first contact arrangement disposed in the first card slot for contacting contacts of a first memory card inserted in the first card slot;
a second contact arrangement disposed in the second card slot for contacting contacts of a second memory card inserted in the second card slot;
a first controller chip, electrically connected to the first contact arrangement, for independently accessing the first memory card; and
a second controller chip, electrically connected to the second contact arrangement, for independently accessing the second memory card.

12. The card reader as claimed in claim 11, wherein the first controller chip comprises a first ground pin, and the second controller chip comprises a second ground pin, wherein the first ground pin and the second ground pin are electrically connected to the other one.

13. The card reader as claimed in claim 11, wherein the first controller chip comprises a first power pin, and the second controller chip comprises a second power pin, wherein the first power pin and the second power pin are electrically connected to the other one.

14. The card reader as claimed in claim 11, wherein an external shape and dimensions of first contact arrangement follows a SD memory card standard, and an external shape and dimensions of second contact arrangement follows a Compact Flash (CF) memory card standard.

15. The card reader as claimed in claim 11, wherein the first controller chip is disposed on the first surface of the substrate and the second controller chip is disposed on the second surface of the substrate.
